(19) United States
(12) Patent Application Publication
(10) Pub. No.: US 2013/0060476 A1
(43) Pub. Date: Mar. 7, 2013

(54) PROCESSING GEOPHYSICAL DATA

(71) Applicant: Colin Thomson, Cambridge (GB)

(72) Inventor: Colin Thomson, Cambridge (GB)

(73) Assignee: WESTERNGECO L.L.C., HOUSTON, TX (US)

(21) Appl. No.: 13/583,601

(22) PCT Filed: Mar. 3, 2011
(86) PCT No.: PCT/IB11/00463

§ 371 Date: Nov. 19, 2012

(30) Foreign Application Priority Data
Mar. 11, 2010 (GB) 1004025.1

(51) Int. Cl. G01V 1/30; G06F 17/10

(52) U.S. Cl. 702/14; 703/2

(57) ABSTRACT

The present invention relates to a method of processing seismic data and other geophysical data such as acoustic or electromagnetic data. In particular the method is applicable to seismic data extrapolation and migration techniques such as, for example, one-way and two-way wave-equation migration. The method comprises determining, in the space-time domain, an integral of the product of a kernel and a function of the geophysical data over an integration domain from the values of the function at a plurality of discrete data points within the integration domain by defining a plurality of cells in the integration domain, each vertex of a cell being at a respective one of the data points; obtaining an interpolant of the function over a selected cell using local interpolation; and integrating, in the space-time domain, the product of the kernel and the interpolant for the selected cell.

### BACKGROUND

The present invention relates to a method of processing seismic data and potentially other geophysical data such as acoustic or electromagnetic data. It is applicable to seismic data extrapolation and migration techniques such as, for example, one-way and two-way wave-equation migration. It may also be applied in seismic modelling or simulation.

In seismic modelling or processing one may need to compute integrals of the general form

$$I = {\int }_{D} G ( x , y ) f ( y ) d y . \qquad ( 1.0 )$$

In equation (1), f is a function related to the acquired seismic data (for example the particle displacement or velocity, or pressure), x and y are each space-time multi-component variables or vectors, and D is an integration domain. G is a function of both vector variables, and it is known as the “kernel” of the integral. One particular class of function playing the role of kernel is the class of wave equation “Green functions” or fundamental solutions.

A seismic survey is carried out by disposing seismic sensors (or “receivers”) at multiple locations (for example on or in the earth's surface or within a body of water), and causing seismic energy to be emitted into the earth at other locations. Seismic data are acquired at each sensor location, as a result of the seismic wavefield being sampled at the sensor location. As the seismic sensors are positioned at discrete locations, seismic data are acquired only at those discrete locations. These points at which the seismic data are known will hereinafter be referred to as “data points”.

One particular problem in processing seismic data is that, since the seismic data are generally known only at certain points in the integration domain D (even though the underlying seismic wavefield is continuous), the value of the function f is also known only at certain points in the integration domain D. However, the functions G and f are generally continuous functions of their respective variables. As a result, computing an integral having the form of equation (1.0) requires taking account of the fact that the values of the function f are known only at certain points. It also requires taking into account the form of the kernel G, which is singular in important cases.

In seismic migration or imaging, data may in general be processed in one of a number of domains, such as, for example the frequency-wavenumber (f-k) domain, the frequency-space (f-x) domain or the space-time (x-t) domain. Use of one of these domains may provide advantages or disadvantages compared to use of another domain. For example, some basic seismic data processing theory involves integrals or integral operators with kernels that are singular or near singular in the space-time domain. By “singular” (or “near-singular”) is meant that the amplitude of the kernel becomes infinite (or becomes very large in a small volume) at one or more points in the space-time domain. Examples are integrals involving Green-function kernels, as used in wavefield up/down directional splitting, or annihilation, or as could be used in wavefield interpolation and extrapolation.

A singular or near-singular kernel presents computational difficulties. Unfortunately, the sharp features of the operator kernel near the singularity are physically important, as they “analyze” short wavelength variations in the data, and incorrect treatment of the computation near the singularity will lead to incorrect results. Such computations are therefore commonly implemented using either the frequency-wavenumber domain or the frequency-space domain, to avoid the problem of the singular or near-singular kernel in the space-time domain.

The general principle of performing the computations in the frequency-wavenumber domain or the frequency-space domain is understood. However, the integral-operator kernels tend to be quite localized in the space-time domain, so that performing the integration in the space-time domain may have advantages, if the singularities of the kernel could be properly handled during the integration. Indeed, the integration must be performed in the space-time domain in order to be able to use the operator tools in conjunction with time-domain finite-difference tools (e.g. in reverse-time migration RTM).

### SUMMARY

A first aspect of the invention provides a method of processing geophysical data, the method comprising determining, in the space-time domain, an integral of the product of a kernel and a function of the geophysical data over an integration domain from the values of the function at a plurality of discrete data points within the integration domain, wherein the method comprises:
(a) defining a plurality of cells in the integration domain, each vertex of a cell being at a respective one of the data points;
(b) obtaining an interpolant of the function over a selected cell using local interpolation; and
(c) integrating, in the space-time domain, the product of the kernel and the interpolant for the selected cell.

The method may be applied to equations having the general form of equation (1.0).

In important cases, such as the isotropic elastic case or the acoustic case, it has been found that the use of local interpolation to interpolate the data function for a cell has the effect of making it possible to evaluate the integral, for a cell, of the product of the kernel x the interpolated value of f analytically in the space-time domain. There is no need to approximate the kernel around its singularity or near-singularity at R=0. This simplifies the integration, and removes a possible source of error.

Working in the space-time domain is also computationally efficient, since the kernel has a compact footprint along the time axis in that domain. In addition, space-time integration can be truncated where the kernel tails are weak, giving a physically attractive way to limit the integration range, a practical necessity.

The method may comprise performing (b) and (c) for each cell defined in the integration domain.

The method may comprise determining a weight for a data point from the results of (c) for each cell having the data point as a vertex. It may comprise determining a weight for a data point as the average of the results of (c) for each cell having the data point as a vertex.

The method may comprise:
(d) multiplying the value of the function at each data point by the weight determined for that data point; and
(e) summing the results of (d).

The method may comprise outputting the result of (e).

The interpolarit for a cell may be determined as the average of the values of the function for the data points at each vertex of the cell. It may alternatively be determined using one of: bilinear interpolation, trilinear interpolation, bicubic interpolation or tricubic interpolation, or other such local interpolation methods.

Processing the geophysical data may comprise determining an up-going and/or a downgoing component of the geophysical data.

Alternatively, processing of the geophysical data may comprise annihilating the wavefields on a plane or imposing a radiation condition at that plane.

Alternatively, processing the geophysical data may comprise extrapolating the geophysical data away from the plane.

The method may comprise determining one or more parameters relating to physical properties of the earth's interior from the processed geophysical data.

The method may be a processor-implemented method.

A second aspect of the invention provides a method of seismic surveying comprising:
propagating an acoustic, elastic or electromagnetic field through at least one subsurface layer of the earth;
acquiring geophysical data at a plurality of discrete locations;
processing the geophysical data according to a method of the first aspect; and
determining one or more parameters relating to physical properties of the at least one subsurface layer using the processed geophysical data.

Other aspects of the invention provide a complementary apparatus and computer-readable medium.

A further aspect of the invention provides a method of determining an integral of the product of a kernel and a function of the geophysical data over an integration domain from the values of the function at a plurality of discrete data points within the integration domain, the method comprising:
(a) defining a plurality of cells in the integration domain, each vertex of a cell being at a respective one of the data points;
(b) obtaining an interpolant of the function over a selected cell using local interpolation; and
(c) integrating, in the space-time domain, the product of the kernel and the interpolant for the selected cell.

The present invention provides a method of discretizing, in the space-time domain, integral operators that contain kernels having a singularity or near-singularity and a relatively compact form in the integration domain so that these operators may be applied accurately and efficiently to sampled geophysical data. The invention respects the singularity of the kernel, so that the action of the integral operator on data containing short-wavelength signals is physically appropriate. The plane-wave spectrum of the operator is respected and the operator is only truncated at large offsets and late times, where the tails of the kernel are weak. As a result, the action of the operator on short horizontal wavelength data, such as horizontally travelling surface waves or turning waves near their turning points, is physically meaningful. The sharp features of the Green function analyze the finer-scale features in the data (where “finer-scale” means within limits imposed by the original data sampling.)

The invention allows integrals of the general form given in equation (1) to be computed in the space-time domain, thereby allowing them be integrated with time-domain numerical modelling tools.

The method may be applied to, for example, integral operators having a Green's function as their kernel, and also to integrals with kernels that depend on gradients of the Green function. The invention is also capable of discretizing operators with different kernels, such as reflection operators. The invention should be useful in various geophysical processing, modelling and inversion/imaging tasks such as, for example wavefield up/down separation, and extrapolation.

### BRIEF DESCRIPTION OF THE DRAWINGS

Embodiments of the invention will now be described with reference to the accompanying figures, in which:

FIGS. 1A and 1B show a 2-D space-time integration domain;

FIG. 2 is a block flow diagram illustrating the principal steps of a method according to one embodiment of the present invention;

FIG. 3 is a section through the earth illustrating redatuming a recording surface; and

FIG. 4 is a schematic block diagram of an apparatus according to one embodiment of the present invention.

It is noted that the embodiments of the invention may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In essence, the integral of equation (1.0) is to be carried out by assigning a weight to each data point. The value of f(y) at a data point is multiplied by the weight for that data point. This is repeated for each data point, and the integral is estimated by summing, over all data points, the weighted value of f(y) at a data point. It is required that the weights given to each data point are chosen such that the result of the summation is a good approximation to the true value of the integral.

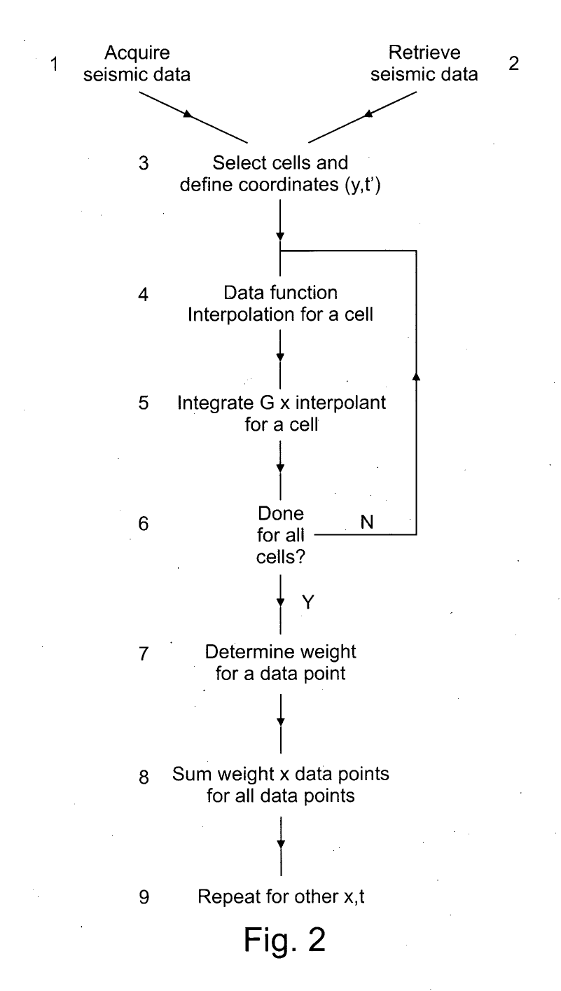

FIG. 2 is a block flow diagram illustrating the principal steps of a method according to one embodiment of the invention. The method assumes that it is desired to compute an integral having the general form of equation (1.0) for data, for example seismic data, that is known only at discrete data points. The invention may be carried out in connection with the acquisition of seismic data or other geophysical data, in which case the method initially comprises the step, step 1, of acquiring seismic data. The data may be acquired using any suitable acquisition technique. The method may alternatively be applied to pre-existing data, in which case step 1 is replaced by the step, step 2, of retrieving pre-existing data from storage.

At step 3, cells are defined over the integration domain. In the simplest case, where the data points are arranged on a regular 2-dimensional grid, the cells may be square cells having a data point at each vertex, but the invention is not limited to use with data points arranged in a regular array nor to data points arranged on a 2-dimensional surface. Any suitable technique may be used to define the cells. The cells are defined in the space-time domain.

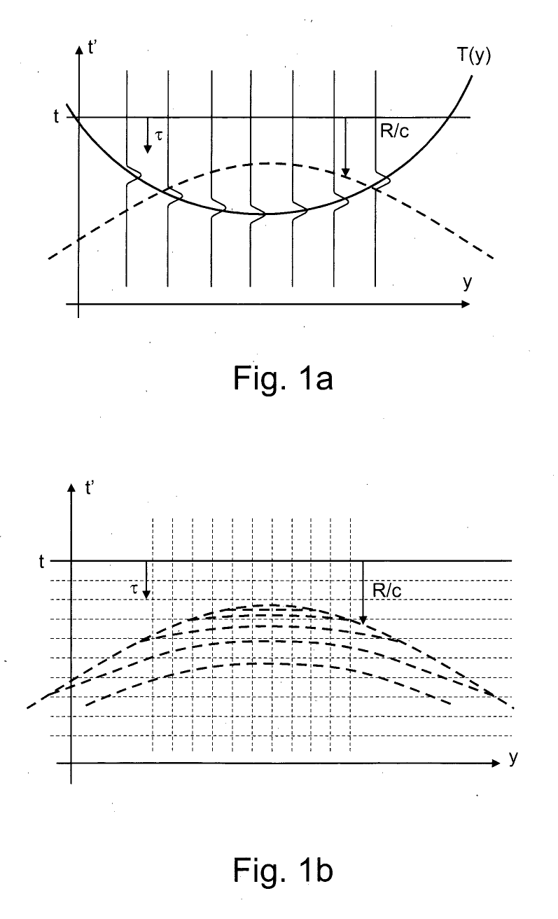

FIG. 1b shows the space-time integration domain for the case of two space dimensions (2D). It is assumed that the data points are arranged on a regular 2-dimensional grid, so that the cells may be rectangular cells (the dimensions/units along the two axes are different). The cells are indicated by the horizontal and vertical broken lines.

At step 4, the value of the function ƒ is determined for a cell by a local interpolation technique. A “local interpolation technique” is a technique that determines the value of the function ƒ for a cell using only the values of f, and possibly the derivatives of ƒ, at the vertices of that cell. Any suitable local interpolation technique may be used.

The simplest approach for determining the value of the function ƒ for a cell is to assume that, within each cell, the data function ƒ is a constant (but to allow the value of ƒ to vary from one cell to another.) For example, the value of the function ƒ for a cell may be taken to be the average of the values of the function ƒ at each of the vertices of the cell.

A more refined approach could be based on schemes such as bilinear or bicubic interpolation (or trilinear or tricubic interpolation in the 3-D case) (although other such local interpolation methods may be used). These are described in more detail below.

At step 5, the product of G x the interpolated value of ƒ for a cell is integrated. It has been found that the use of local interpolation to interpolate the data function for a cell has the effect of making it possible to evaluate this integral analytically in certain cases. If the point R=0 occurs within a cell, the integral is still finite and may be evaluated, analytically or otherwise, because Green functions and their first spatial derivatives have integrable singularities for physical reasons.

At step 6 a determination is made whether steps 4 and 5 have been carried out for all cells defined at step 3. If step 6 yields a “no” determination, steps 4, 5 and 6 are repeated until steps 4 and 5 been carried out for all cells and a “yes” determination is obtained at step 6.

At step 7, the “weights” to be applied to the value of a data point are determined from the results of step 5. In the 2-D [or 3-D]case of a regular array of data points, a data point is a vertex for 4 [or 8] cells, so the results of step 5 for a particular cell make a contribution to the weights for the 4 [or 8] data points at the vertices of the cell.

Conversely, the weight for a data point will receive contributions from the 4[8] cells for which that data point is a vertex. In the simplest embodiment of the invention, the weight for a data point is taken to be the sum of, or the average of, the results of step for each cell for which that data point is a vertex.

Step 7 is carried out for each cell defined at step 3.

At step 8, the value of each data point is multiplied by the respective “weight” calculated for that data point at step 7, and the weighted values are summed to give the estimate of the integral.

Step 9 of FIG. 2 is described below.

A more detailed description of one embodiment if the invention will now be given.

This example relates to an integral of the form:

I(x,t)=∫₀^{∞}∫ [symbol] _{ⁿ⁻¹}G(x,y,t−t′)ƒ(y,t′)dydt′, (2.0.1)

It can be seen that the integral in equation (2.0.1) has the same general form as equation (1.0). The integration is in the space-time domain.

The kernel of the integral operator is the function G(x,y,t−t′) of equation (2.0.1), which is a Green's function. (Strictly, the Green's function is a tensor quantity, and G(x,y,t−t′) is a component of the Green's function tensor.) The field f (y, t′) represents the seismic data given on the surface of integration. The seismic data are assumed causal and hence the lower time limit of t′=0 in equation (2.0.1).

In equation (2.0.1), t is time, x is an observation point n-vector and y is a position constrained to be in the surface of integration [symbol] ⁿ⁻¹ ((n−1) vector), where n=2, 3. (Although represented in bold text, y is not a vector quantity in the 2-D case) The point x may be near or on the surface of integration and z will be used for its normal component (i.e. depth). The Green function in [symbol] ⁿ is here denoted G(x,y,t) and y is considered to be its source point, though reciprocity applies.

The values of the field f (y, t′) are known only at points lying on a discrete grid in the (y, t′) plane.

For the scalar wave equation and a homogeneous medium with wavespeed c, the Green function in [symbol] ³ is

$$G ( x , y , t ) = \frac{1}{4 π R} δ ( t - R / c ) , \qquad ( 2.0 .2 )$$

where R=|x−y|. In [symbol] ² it has the form

$$G ( x , y , t ) = \frac{1}{2 π} \frac{H ( t - R / c )}{{( {t}^{2} - {R}^{2} / {c}^{2} )}^{1 / 2}} . \qquad ( 2.0 .3 )$$

It is readily apparent that the Green's function of equation (2.0.2) has a prominent singularity at its origin (R=0). t can also be shown that the Green's function of equation (2.0.3) has a prominent singularity at its origin, as well as the more obvious singularity at t=R/c (for R≠0). It should be understood that a Green's function may have singularities (such as a delta function or infinite step) along the time axis, even away from R=0. Singularities along the time axis are widely appreciated to be integrable with just one integration along the time axis and the result is a finite number. However, the singularity at R=0 is a more prominent singularity, and is more difficult to handle during integration as it additionally requires integration over other dimensions (i.e. space cells).

Expected applications of the invention will be concerned mainly with wavefield operators using Cartesian coordinates, and the invention will therefore be described with reference to Cartesian coordinates. The invention is not however limited to Cartesian coordinates. It should also be noted that, the local nature of the singularities means that the invention can also be applied to non-planar surfaces of integration, and/or to irregularly sampled data (ie, where the data points lie on an irregular grid).

The 2D case (n=2) will be considered, as an example . . . .

In order to avoid excessive use of a bold font for a scalar quantity, we now let y denote the scalar distance along the line of integration [symbol] (the “seismic survey line”). Note though, that x will still represent a general position 2-vector with a z component. FIG. 1a shows the situation in which the wavefield ƒ is due to a simple curved wavefront (e.g. ƒ(y,t′)=ƒ(t′−T(y)), with T a quadratic function of y) arriving at [symbol] . In FIG. 1a, the dashed curve is the “arrival-time” curve t′=t−R/c of the Green function, and the full curve is the function T(y). FIG. 1a also shows some simple example waveforms representing the data due to a curved wavefront arriving at the integration surface, or survey line, [symbol] .

For a particular observation point x, with z nonzero in general, and a particular time t, the curve in (y,t′) satisfying t′=t−R(x, y)/c (shown dashed in FIGS. 1a, 1b) has special significance. It is the locus of the Green-function singularity (for R≠0) in equation (2.0.1). It will be referred to as an arrival-time curve, but note that this means for the Green-function kernel and not for the, possibly numerous, arrivals contained in the input wavefield ƒ.

Substituting the 2D Green function of equation (2.0.3) into equation (2.0.1), introducing the alternative time variable τ=t−t′ and taking into account the causality of both the wavefield ƒ and the Green function, leads to

$$I ( x , t ) = \frac{1}{2 π} {\int }_{ℝ} {\int }_{R / c}^{t} \frac{1}{{( {τ}^{2} - {R}^{2} ( y ) / {c}^{2} )}^{1 / 2}} f ( y , t - τ ) d y d τ \qquad ( 2.1 .1 )$$

for t>R/c, and zero otherwise. This form is convenient because of the simpler form of the square root in the integrand. The partial dependence of R on y is explicitly acknowledged in equation (2.1.1), but one should not forget that it also depends on x.

FIG. 1b shows the space-time integration domain for the case of two space dimensions (2D), showing the data grid and cells from which the template will be computed. The cells in (y, t′) are defined at step 3 of the method of FIG. 2. The arrival-time curve t′=t−R/c, is shown as a bold dashed line. The lighter dashed lines below the arrival-time curve are contours of the magnitude of the operator to be constructed. These depend strongly on the magnitude of the 2D Green function.

The method of the invention requires that the value of the function f for a cell is estimated (step 4 of FIG. 2). As described above, this may be done using any suitable local averaging or interpolation technique including for example linear, bilinear or bicubic interpolation. A bicubic interpolant (Press et al., 1992, pp. 116-120) can be written as

$$f ( y , {t}^{′} ) = {f}_{i} ( y , {t}^{′} ) = ( {\sum }_{m = 0}^{3} {\sum }_{n = 0}^{3} {{f}_{imm} ( y - {y}_{i} )}^{m} {( {t}^{′} - {t}_{i}^{′} )}^{n} ) , \\ {y}_{L} < y < {y}_{U} , {t}_{L}^{′} < {t}^{′} < {t}_{U}^{′} , \qquad ( 2.1 .2 )$$

where (y_{L}, y_{U}) and (t′_{L}, t′_{U}) are the lower and upper boundaries of the cell in the (y, t′) plane and (yᵢ, t′ᵢ) are the coordinates of a reference vertex. In practice, bilinear interpolation (m,n≦1) is much simpler to implement, since only the four values of ƒ at the cell vertices are needed for the construction of the coefficients fᵢₘₙ for bilinear interpolation. For bicubic interpolation, the coefficients fᵢₘₙ depend on the values of ƒ and three of its derivatives at the four vertices.

In an embodiment in which the bicubic interpolation of equation (2.1.2) is used, then substituting equation. (2.1.2) into equation. (2.1.1) shows that factors such as (t−τ−t′ᵢ)ⁿ arise. One may define τᵢ=t−t′ᵢ, which in effect relates grid cells in the (y, t′) plane to ones in the (y, τ) plane. As t increases, a given τᵢ (i.e. cell in the latter plane) corresponds to an increasing t′ᵢ (i.e. a cell at later times in the former plane). The interpolant may now be written with factors (τᵢ−T)ⁿ and the generic form of the integrals that must be performed across a (y, τ) cell (step 6 of FIG. 2) may be written as:

$${\tilde{I}}_{imm} = \frac{1}{2 π} {\int }_{{y}_{L}}^{{y}_{U}} {\int }_{max ( R / c , {τ}_{L} )}^{{τ}_{U}} \frac{1}{{( {τ}^{2} - {R}^{2} / {c}^{2} )}^{1 / 2}} {y}^{m} {τ}^{n} d y d τ . \qquad ( 2.1 .3 )$$

The limits of τ relate to those of the corresponding (y, t′) cell at time t via τ_{L}=−t′_{U} and τ_{U}=t−t′_{L}.

It is important to note that the integrals in equation (2.1.3) can be performed analytically (that is, without need for further approximation or estimation), thus capturing accurately the singular case τ²−R²/c²=0. This arises from the use of local interpolation to interpolate the value of the function ƒ for a cell

The resulting integrals are used to define the weights to be applied to the discrete samples of ƒ at the cell vertices (ie the data points). As explained above with reference to step 7 of FIG. 2, the integral for a cell contributes to the weight to be assigned to the data points at every vertex of the cell, thus defining the output of the operator acting on the (interpolated) data.

The integral may then be computed by determining the weight to be applied to each data points from the Iᵢₘₙ determined for each cell, multiplying the value of ƒ for each data point by the weight determined for that data point, and summing the weighted discrete values of ƒ for all data points.

It should be noted that equation (2.0.1) yields I(x, t), that is the value of I for a particular observation point (x) and time (t). It will generally be required to repeat the calculation for different observation points and/or for different times, and this is indicated as step 9 in FIG. 2.

The above example relates to the 2-D case. The same basic idea applies to the 3D case with the simple Green function given by equation (2.0.2).

Sometimes the operator “kernel”, G in the example above, is not known in such relatively simple functional forms. In generally anisotropic elastic media, G may itself be given by an integral representing a sum of plane waves. In such a case, the details of the operator template construction are more complicated, but the key step is exactly same. Namely, the data are approximated in the data-domain cells by simple functions that is by local interpolation, after which the necessary integration is done “exactly”. The same principle applies to reflection operators given by plane-wave sums.

Examples of advantages of the invention include, but are not limited to the following:
1. Since the kernel singularity is respected, the action of the integral operator on data containing short-wavelength signals is physically appropriate. The sharp features of the Green function analyze the finer-scale features in the data, where finer-scale clearly means within the limits imposed by the original data sampling.
2. The truncation of the integrals where the kernel is weak in the space-time domain, which suggests desirable weak aperture-dependence of the results.
3. As the method operates in the space-time domain, it may be combined with time-domain finite-difference modelling, as used in reverse-time migration (RTM) for example.

One possible application of the present invention is to up/down wavefield splitting. A seismic receiver records the overall wavefield at the receiver location, but in some applications it is desirable to know the up- and downgoing components of the wavefield. Given the total acoustic wavefield (e.g. the total pressure u) and its normal derivative on a horizontal surface of integration [symbol] ⁿ⁻¹, n=2, 3, the up- and downgoing components (+/−) are given by:

u^{±}(x,t)=½(u(x,t)±∫₀^{∞}∫ [symbol] _{ⁿ⁻¹}G^{α}(x,y,t−t′)∂_{z}u(y,t′)dydt′) (2.2.1)

In this case, the normal (i.e. z) derivative of the pressure corresponds to the data field ƒ of equation (1.0), but otherwise the integral here is precisely of the form discussed above.

Since the Green function singularity is kept intact in the invention, it is possible to apply the above splitting equation to wavefields with evanescent plane-wave components. For example, it is possible to apply the method to a wavefield which contains local turning-wave components. Such a decomposition is singular in the plane-wave domain, but in the space-time domain (or space-frequency domain) it is well defined; the up/down component wavefields are finite and they may be interpreted in terms of medium properties. For example, GB 2443436 discloses a method of direct waveform inversion of turning waves to obtain parameters that characterise the interior of the earth or subsections of the earth.

Another application of the invention is to wavefield extrapolation. Given a downgoing pressure wavefield u on [symbol] ⁿ⁻¹, n=2, 3, and neglecting forward/backward coupling, the field at a deeper point x is given by

u(x,t)=2∫₀^{∞}∫ [symbol] _{ⁿ⁻¹}∂_{z}G^{α}(x,y,t−t′)u(y,t′)dydt′, (2.2.2)

[symbol]

Equation (2.2.2) again has the general form of equation (1.0), with the downgoing field u itself corresponding to the field f of equation (1.0). Note that in equation (2.2.2) the kernel of the operator is the vertical or z derivative of the Green function. This kernel is more singular than the Green function itself, but it is still integrable and the method of the invention is still applicable.

Other applications of the invention are to annihilating a wavefield at a plane, to imposing a radiation condition at a plane, to imposing an absorbing boundary condition at a plane, and imposing a partially-absorbing boundary condition (or, equivalently, applying a reflection operator) at a plane.

A further application of the invention, in the case of elastic data (or “multi-component” data), is to apply up/down wavefield separation on the data to separate the up-going component at an interface, such as the land surface, from the down-going component. This may be applied as a pre-processing step in waveform inversion, intended to mitigate the effect of surface waves and near-surface diving or turning waves.

One particular application of the invention is near-surface characterization using land seismic data. (The “near surface” of the earth refers to the part of the earth at or just below the earth's surface; this generally has properties that are different from the properties of the underlying layers of the earth owing to effects such as weathering.) The near surface of the earth has a large influence on the quality of land exploration-seismic data, mainly due to significant surface-wave energy and local structural complexity. Compensation for the near-surface effect is one of the industry major challenges, yet most current processing methods use simplified assumptions on both the wavefields and the near-surface structural complexity. Wave equation based processing methods, such as waveform inversion, hold the promise of improved discrimination between surface-wave energy and the body-wave signals from deeper reservoir targets. There are many questions related to the best way of applying such methods, with possible strategies ranging from the use of simple acoustic approximations through to the redatuming of vector elastic wavefields down to some intermediate depth level prior to any actual inversion.

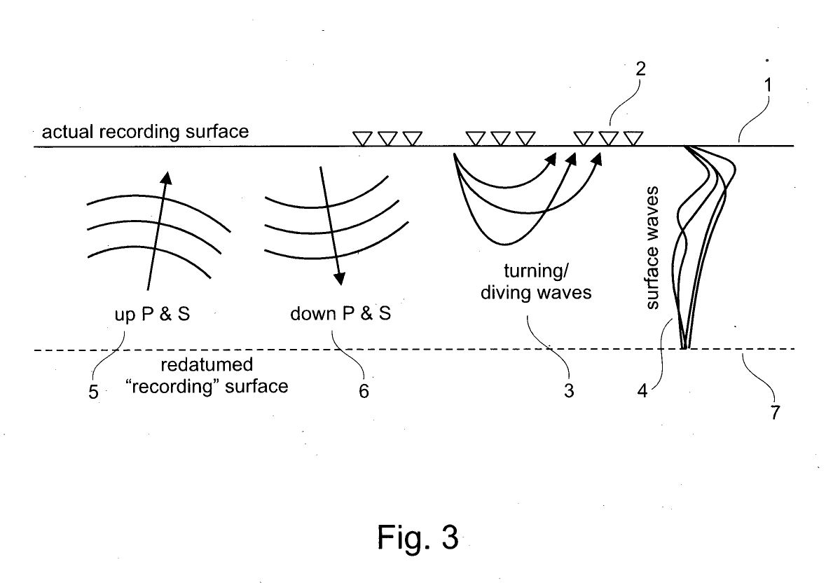

FIG. 3 is a schematic partial section of the earth, illustrating the principle of redatuming seismic data.

In a seismic survey, receivers 2 disposed on the earth's surface 1 acquire seismic data consequent to actuation of a source (not shown). In addition to desired events arising from seismic energy propagating into the earth and undergoing reflection at a geological feature in the earth's interior, the seismic data acquired at the receivers will also include other, undesired events. Two types of undesired events are shown in FIG. 3. Examples of undesired event include “turning/diving” waves, denoted generally at 3, where seismic energy propagates a short way into the earth before turning and “surface” waves, denoted generally at 4, where seismic energy propagates from the source to a receiver 2 wholly within a layer near the earth's surface 1. The “turning/diving” waves 3 and “surface” waves 4 do not penetrate deep into the earth's interior and hence cannot convey any information about geological features deep within the earth.

The principle of redatuming seismic data idea is based on the premised that if the seismic data really could be recorded at a modest distance, say 500 m, below the earth's surface 1, they would look simpler and be more interpretable in terms of deeper targets of interest (e.g. imaging would be easier). This is because the surface waves 4 and, to some extent, shallow turning/diving waves 3 are less energetic at depth (as indicated in FIG. 3). Redatuming seismic data recorded at the earth's surface 1 to a virtual surface 7 within the earth is an attempt to estimate such subsurface data—ie, to estimate, from the seismic data acquired at the earth's surface, the seismic data that would have been acquired at receivers disposed on the virtual recording surface 7.

The redatuming will require an elasticity model of the earth (to give the speed of P & S waves, density etc.). This model does not need to be particularly accurate and it may be laterally varying because space-domain operators will be used. The model should be sufficiently smooth and realistic such that at some depth the effects of surface waves 4 and near-surface turning/diving waves 3 are insignificant. The up and downgoing signals, denoted as 5 and 6 in FIG. 3, from deeper in the Earth will then be clearer. If desired, these important signals may be returned to the surface, removing the imprint of the approximate elasticity model used to filter out the unwanted parts of the wavefield.

Redatuming seismic data may be carried out by, initially, decomposing the data recorded by the receivers 2 to obtain the downgoing component of the recorded data, for example using equation (2.2.1). Equation (2.2.2) may then be applied to the downgoing component, to obtain the redatumed wavefield at the virtual surface 7. The method of the invention may be applied to one or preferably both of the computation of the downgoing component according to equation (2.2.1) and the computation of the redatumed wavefield according to equation (2.2.2).

Since this redatuming method is based on the properties of the seismic wave equation, it will give different results to filtering based solely on frequency-wavenumber separation of signals. It opens up the possibility to examine different types of near-surface structural effect, viewed as an effective medium problem, and it permits the problem of wavefield inversion for near-surface properties to be addressed from various perspectives.

Other possible applications of the invention in the processing of seismic/geophysical data include the following:

The invention may be applied to absorbing boundary conditions in modelling by finite-difference methods;

Since reflection operator kernels can also be used in methods of the invention, the invention may be applied to partially reflecting boundary conditions for gridded wavefield modelling;

Embodiments of the invention have been described above with reference to processing seismic (acoustic) data. The invention is not however limited to this, and may potentially be applied to processing other data, for example electromagnetic data.

The orientation of the plane [symbol] ⁿ⁻¹ need not be horizontal. Its orientation may be chosen subparallel to a target reflector of interest deep within the Earth. It would then be possible to use the templates described to split wavefields into local incident and reflected waves as part of time-domain full-wavefield finite-difference modelling and imaging.

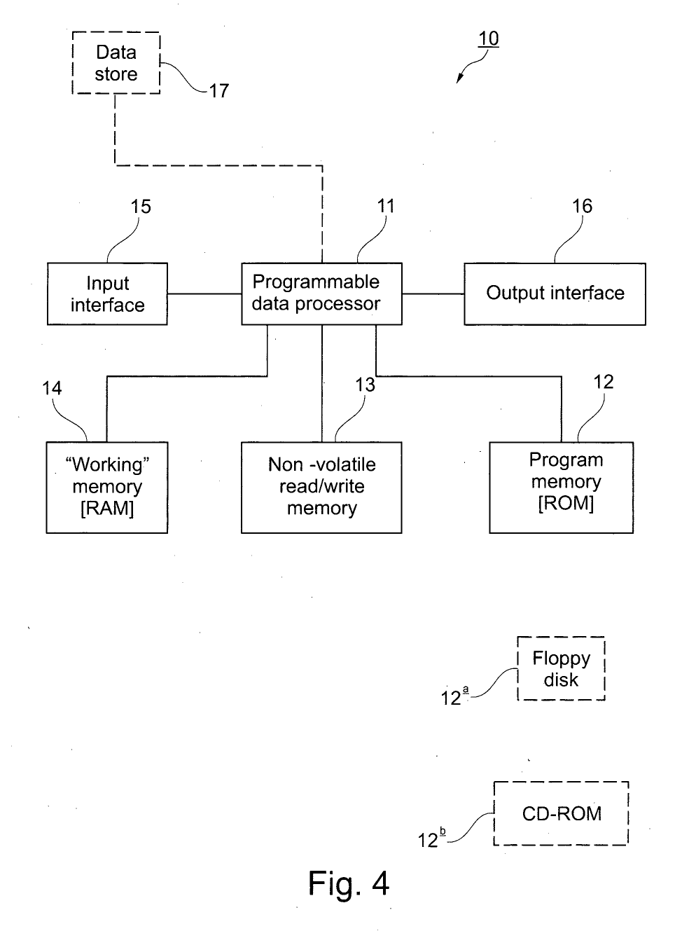

FIG. 4 is a schematic block diagram of a programmable apparatus 10 according to the present invention. The apparatus comprises a programmable data process 11 with a programme memory 12, for instance in the form of a read-only memory (ROM), storing a programme for controlling the data processor 11 to perform any of the processing methods described above. The apparatus further comprises non-volatile read/write memory 13 for storing, for example, any data which must be retained in the absence of power supply. A “working” or scratch pad memory for the data processor is provided by a random access memory (RAM) 14. An input interface 15 is provided, for instance for receiving commands and data. An output interface 16 is provided, for instance for displaying information relating to the progress and result of the method. Data for processing may be supplied via the input interface 14, or may alternatively be retrieved from a machine-readable data store 17.

The programme for operating the system and for performing any of the methods described hereinbefore is stored in the programme memory 12, which may be embodied as a semi-conductor memory, for instance of the well-known ROM type. However, the programme may be stored in any other suitable storage medium, such as magnetic data carrier 12a, such as a “floppy disk”, CD-ROM or DVD-ROM 12b.

1. A method of processing geophysical data, the method comprising determining, in the space-time domain, an integral of the product of a kernel and a function of the geophysical data over an integration domain from the values of the function at a plurality of discrete data points within the integration domain, wherein the method comprises:
(a) defining a plurality of cells in the integration domain, each vertex of a cell being at a respective one of the data points;
(b) obtaining an interpolant of the function over a selected cell using local interpolation; and
(c) integrating, in the space-time domain, the product of the kernel and the interpolant for the selected cell.

2. A method as claimed in claim 1 and comprising performing (b) and (c) for each cell defined in the integration domain.

3. A method as claimed in claim 2 and further comprising determining a weight for a data point from the results of (c) for each cell having the data point as a vertex.

4. A method as claimed in claim 2 and comprising determining a weight for a data point as the average of the results of (c) for each cell having the data point as a vertex.

5. A method as claimed in claim 3 and comprising
(d) multiplying the value of the function at each data point by the weight determined for that data point; and
(e) summing the results of (d).

6. A method as claimed in claim 5 and comprising outputting the result of (e).

7. A method as claimed in claim 1 wherein (b) comprises determining the interpolant for a cell as the average of the values of the function for the data points at each vertex of the cell.

8. A method as claimed in claim 1 wherein (b) comprises determining the interpolant for a cell from the values of the function for the data points at each vertex of the cell using one of: bilinear interpolation, trilinear interpolation, bicubic interpolation or tricubic interpolation.

9. A method as claimed in claim 1 wherein processing the geophysical data comprises one or more of:
determining an up-going and/or a downgoing component of the geophysical data;
annihilating a wavefield at a plane;
imposing a radiation condition at a plane;
imposing an absorbing boundary condition at a plane; and
imposing a partially-absorbing boundary condition at a plane

10. A method as claimed in claim 1 wherein processing the geophysical data comprises extrapolating the geophysical data away from a plane.

11. A method as claimed in claim 1 wherein the geophysical data are elastic wavefield data.

12. A method as claimed in claim 11 wherein processing the data comprises performing up/down wavefield separation on the data.

13. A method as claimed in claim 1 and further comprising determining one or more parameters relating to physical properties of the earth's interior from the processed geophysical data.

14. A method as claimed in claim 1 wherein the method is a processor-implemented method.

15. A method of seismic surveying comprising:
propagating an acoustic or electromagnetic field through at least one subsurface layer of the earth;
acquiring geophysical data at a plurality of discrete locations;
processing the geophysical data according to a method as defined in claim 1; and
determining one or more parameters relating to physical properties of the at least one subsurface layer using the processed geophysical data.

16. A computer-readable medium containing instructions that, when executed by a processor, cause the processor to perform a method as defined in claim 1.

17. An apparatus for processing geophysical data, and adapted to determine, in the space-time domain, an integral of the product of a kernel and a function of the geophysical data over an integration domain from the values of the function at a plurality of discrete data points within the integration domain, wherein the apparatus comprises:
(a) means for defining a plurality of cells in the integration domain, each vertex of a cell being at a respective one of the data points;
(b) means for obtaining an interpolant of the function over a selected cell using local interpolation; and
(c) means for integrating, in the space-time domain, the product of the kernel and the interpolant for the selected cell.
